(19) United States
(12) Patent Application Publication
(10) Pub. No.: US 2026/0304358 A1
(43) Pub. Date: Oct. 1, 2026

(54) METHODS OF SELECTION BY A CLIENT WIRELESS TRANSMIT/RECEIVE UNIT (WTRU) OF A POSITIONING SERVER WTRU PER STATUS OF A WTRU

(71) Applicant: InterDigital Patent Holdings, Inc., Wilmington, DE (US)

(72) Inventors: Jung Je SON, Warrington, PA (US); Taimoor ABBAS, Sainte-Julie (CA); Anuj SETHI, Ottawa (CA); Alec BRUSILOVSKY, Dowingtown, PA (US)

(73) Assignee: InterDigital Patent Holdings, Inc., Wilmington, DE (US)

(21) Appl. No.: 19/478,403

(22) PCT Filed: May 10, 2024
(86) PCT No.: PCT/US2024/028919

§ 371 Date: Oct. 24, 2025

Related U.S. Application Data
(60) Provisional application No. 63/465,690, filed on May 11, 2023.

(51) Int. Cl. H04W 64/00; H04W 48/16; H04W 92/18

(52) U.S. Cl. CPC H04W 64/00; H04W 48/16; H04W 92/18

(57) ABSTRACT

A sidelink (SL) positioning client wireless transmit/receive unit (WTRU) may discover a target WTRU and SL reference WTRUs. In an example, an SL position client WTRU may receive at least one of a non-access stratum (NAS) status of a target WTRU or a NAS status of one or more SL reference WTRUs. The SL position client WTRU may select one or more SL reference WTRUS based on the at least one of the NAS status of the target WTRU or the NAS status of the one or more SL reference WTRUs. The SL position client WTRU may select between the target WTRU and an SL reference WTRU, of the selected SL reference WTRUs, to receive an SL positioning service request. The SL position client WTRU may transmit, to the target WTRU or the SL reference WTRU selected to receive the SL positioning service request, the SL positioning service request.

### CROSS-REFERENCE TO RELATED APPLICATION

This application claims the benefit of U.S. Provisional Application No. 63/465,690, filed May 11, 2023, the contents of which are incorporated herein by reference.

### BACKGROUND

Fifth generation of mobile telephony (5G) location service (LCS) provides the functionality to provide the positioning information of a wireless transmit/receive unit (WTRU). The positioning of a WTRU can be supported by radio access technology (RAT) dependent position methods, which rely on, for example, Third Generation Partnership Project (3GPP) RAT measurements obtained by a target WTRU, on measurement obtained by an Access Network of 3GPP RAT signals transmitted by a target WTRU, or on both. Positioning of a WTRU can also be supported by RAT independent position methods which may rely on non-RAT measurements obtained by a WTRU, on other information, or on both.

Location information for one or multiple target WTRUs may be requested by and reported to an LCS client, an application function (AF) within or external to a 3GPP operator network, or a control plane network function (NF) within the 3GPP system. For location requests from an LCS client or an AF, privacy (for example, settings) verification of the target WTRU shall be enabled to check whether it is allowed to acquire the WTRU location information.

### SUMMARY

In an example, a sidelink (SL) positioning client wireless transmit/receive unit (WTRU) may discover a target WTRU and SL reference WTRUs. Specifically, the SL positioning client WTRU may receive a target WTRU's non-access stratum (NAS) status or one or more SL reference WTRUs' NAS status. Further, the SL position client WTRU may select one or more SL reference WTRUs, for an SL positioning operation, based on the at least one of the NAS status of the target WTRU or the NAS status of the one or more SL reference WTRUs. Also, the SL position client WTRU may select between the target WTRU and an SL reference WTRU, of the one or more selected SL reference WTRUs, to receive an SL positioning service request. Moreover, the SL position client WTRU may transmit, to the target WTRU or the SL reference WTRU selected to receive the SL positioning service request, the SL positioning service request.

In another example, the SL positioning service request may include information regarding the target WTRU. In a further example, the SL positioning service request may include information regarding one of the one or more SL reference WTRUs. In an additional example, the NAS status of the target WTRU and the NAS status of the one or more SL reference WTRUs may be received during discovery.

Moreover, the selection between the target WTRU or the selected SL reference WTRU may be based on at least one of the NAS status of the target WTRU or the NAS status of the selected SL reference WTRU, in an example. Additionally, the at least one of the NAS status of the target WTRU or the NAS status of the one or more SL reference WTRUs may be received over a PC5 connection.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example reference model of a fifth generation of mobile telephony (5G)/NextGen network for location service;

FIG. 3 is a procedure diagram illustrating an example of sidelink (SL) positioning by a client WTRU based on status information of a discovered WTRU;

FIG. 4 is a flowchart diagram illustrating an example of SL positioning by a client WTRU based on status information of a discovered WTRU; and

FIG. 5 is a procedure diagram illustrating an example of SL positioning WTRU status sharing between an SL reference WTRU and a target WTRU.

### DETAILED DESCRIPTION

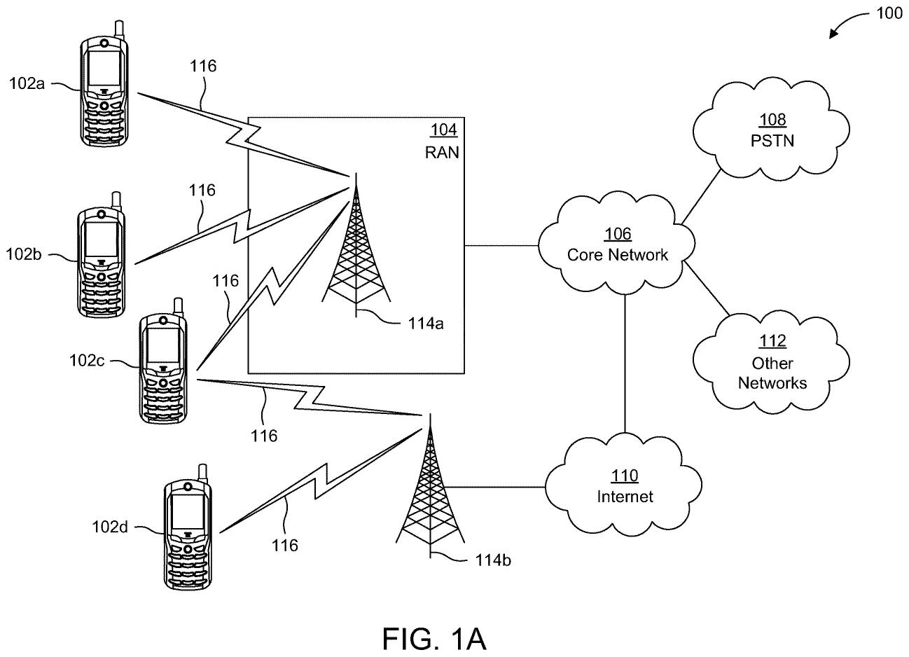

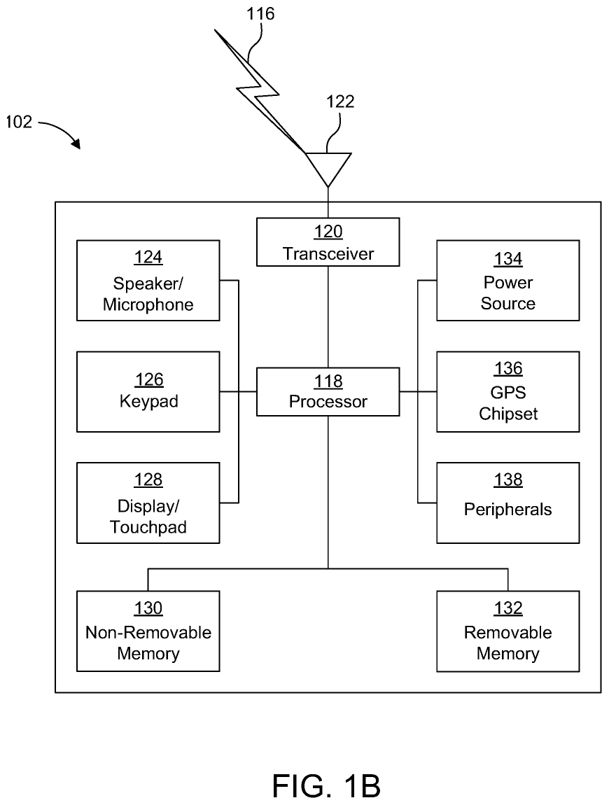

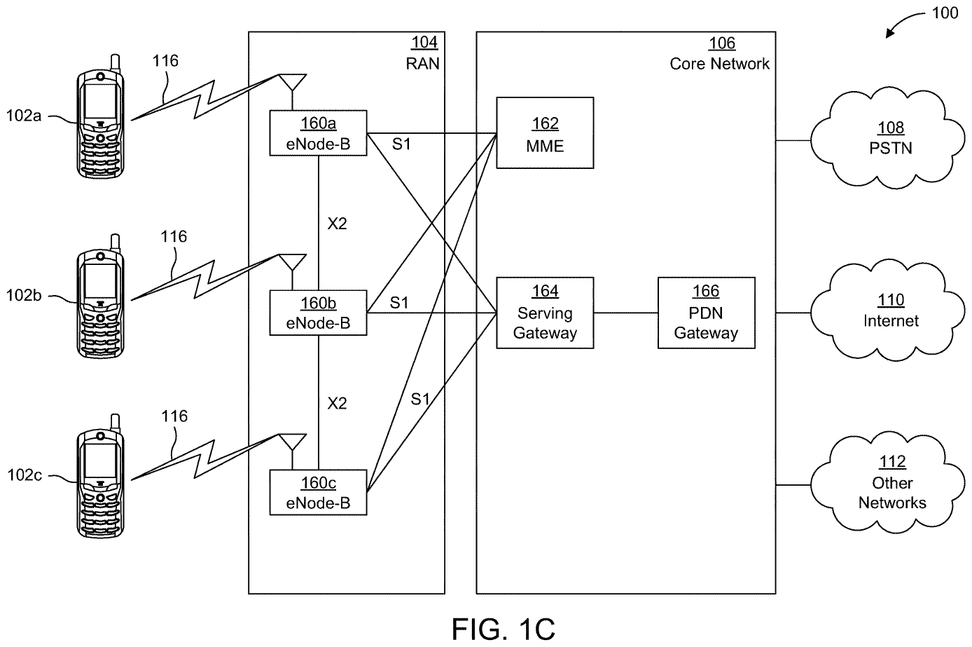

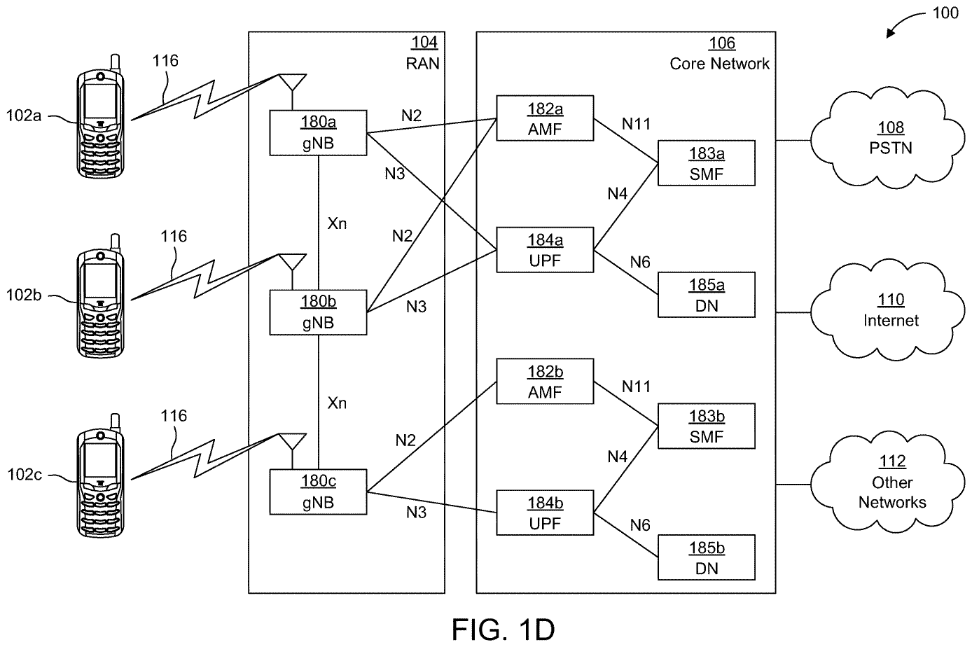

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (for example, associated with particular subframes for both the UL (for example, for transmission) and DL (for example, for reception) may be concurrent and/or simultaneous. The full duplex radio may include an interference management unit to reduce and or substantially eliminate self-interference via either hardware (for example, a choke) or signal processing via a processor (for example, a separate processor (not shown) or via processor 118). In an embodiment, the WTRU 102 may include a half-duplex radio for which transmission and reception of some or all of the signals (for example, associated with particular subframes for either the UL (for example, for transmission) or the DL (for example, for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (for example, 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (for example, containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (for example, handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-Third Generation Partnership Project (3GPP) access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

Fifth generation of mobile telephony (5G) location service (LCS) provides the functionality to provide the positioning information of a WTRU. The positioning of a WTRU can be supported by RAT dependent position methods, which rely on, for example, 3GPP RAT measurements obtained by a target WTRU and/or on measurement obtained by an Access Network of 3GPP RAT signals transmitted by a target WTRU. Positioning of a WTRU can also be supported by RAT independent position methods which may rely on non-RAT measurements obtained by a WTRU and/or on other information.

Location information for one or multiple target WTRUs may be requested by and reported to an LCS client, an application function (AF) within or external to a 3GPP operator network, or a control plane network function (NF) within the 3GPP system. For location requests from an LCS client or an AF, privacy (for example, settings) verification of the target WTRU shall be enabled to check whether it is allowed to acquire the WTRU location information.

There are several different types of location requests supported, including the following: a Mobile Terminated Location Request (MT-LR), a Mobile Originated Location Request (MO-LR), an immediate location request, and a deferred location request. With an MT-LR, an LCS client or AF sends a location request to the 5G Network for the location of a target WTRU. With an MO-LR, a WTRU sends a request to the 5G Network for location related information for the WTRU. With an immediate location request, an LCS client or AF sends or instigates a location request for a target WTRU(s) and expects to receive a response containing location information for the target WTRU(s) within a short time period. The immediate location request may be used for an MT-LR or MO-LR. With a deferred location request, an LCS client or AF sends a location request to the 5G network for a target WTRU(s) and expects to receive a response when an indicated event occurred for the target WTRU at some future time. The deferred location request may be used for an MT-LR.

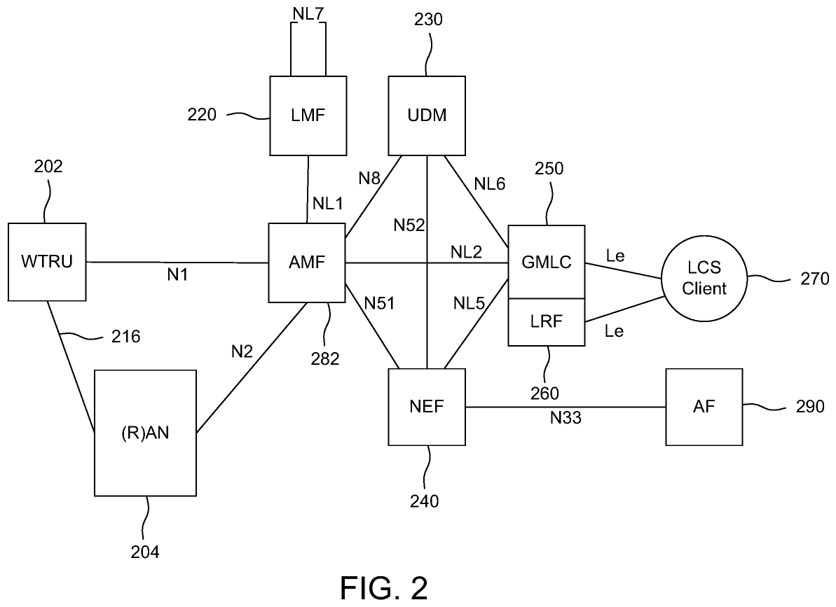

FIG. 2 is a system diagram illustrating an example reference model of a 5G/NextGen network for location service. As shown in an example in system diagram 200, (R)AN 204 here represents NG-RAN, trusted non-3GPP access, or untrusted non-3GPP access. Further, (R)AN 204 may be the same as or similar to RAN 104. Also, (R)AN 204 may communicate with a WTRU, such as target WTRU 202, over interface 216. In addition, interface 216 may be an air interface and may be similar to or the same as air interface 116.

The access network is involved in the handling of various positioning procedures including positioning of a target WTRU, provisioning of location related information not associated with a particular target WTRU 202 and transfer of positioning messages between an AMF 282 or a location management function (LMF) 220 and a target WTRU 202. Target WTRU 202 may be the same as or similar to WTRU 102, and AMF 282 may be the same as or similar to AMF 182.

AFs, such as AF 290, and NFs may access LCS services from a gateway mobile location center (GMLC) 250 in the same 3GPP operator network. LCS clients, such as LCS client 270, may access LCS services from the GMLC 250, and an external AF 290 may access LCS services from a network exposure function (NEF) 240.

The GMLC 250 handles the request from the external LCS client 270, AF 290, or both, via the NEF 240 if the AF 290 is an external AF and forwards the location request to the proper NF. A location retrieval function (LRF) 260 is responsible for retrieving or validating location information and may be collocated with the GMLC 250 or may standalone. An LMF 220 manages the overall coordination and scheduling of resources required for the location of a WTRU that is registered with or accessing the 5G CN, such as CN 106. The LMF 220 may calculate or may verify a final location related information and achieved accuracy. Further, AMF 282 or GMLC 250 may access unified data management (UDM) 230.

Sidelink (SL) positioning, or SL based positioning, service is defined as positioning a WTRU using PC5 to obtain an absolute position, relative position, or ranging information. Ranging refers to the determination of the distance between two or more WTRUs and/or the direction of one WTRU (for example, a target WTRU) from another WTRU (for example, a reference WTRU) via the PC5 interface.

For SL positioning, target WTRU, SL Reference WTRU, SL positioning client WTRU and located WTRU may be defined and used as follows. A target WTRU may be a WTRU whose distance, direction, and/or position is measured with the support from one or multiple SL Reference WTRUs using Sidelink in the Ranging based service and Sidelink positioning. An SL Reference WTRU may be a WTRU, supporting positioning of target WTRU, for example, by transmitting and/or receiving reference signals for positioning, providing positioning-related information, and the like using sidelink communication. A located WTRU may be an SL Reference WTRU of which the location is known or can be known using Uu-based positioning. A located WTRU can be used to determine the location of a Target WTRU using Sidelink Positioning. An SL positioning client WTRU may be a third-party WTRU, other than the SL Reference WTRU or the Target WTRU, which initiates a Ranging/Sidelink positioning service request on behalf of the application residing on the SL positioning client WTRU.

The operation of Ranging/Sidelink Positioning can be performed either as Network-assisted Operation or WTRU-only Operation. In the Network-assisted Operation, one or more 5GC NFs are involved in the service request handling and resulting calculation operations. In the WTRU-only Operation, the service request handling and resulting calculation operations are performed by WTRU.

When Network-assisted operation is used, LMF defined in the 5G Location Service may be used to support triggering SL positioning, coordination of SL positioning operation, and delivering the result to the client. The Ranging/Sidelink Positioning service request can be initiated by a WTRU (for example, an SL Positioning Client WTRU, Target WTRU, SL Reference WTRU, and the like), a 5GC NF, an LCS Client, or an AF.

When WTRU-only operation is used, WTRUs interact with each other over PC5 as necessary in order to perform SL positioning operations. The SL positioning server WTRU is defined to coordinate SL positioning operation and calculate the positioning result. An SL positioning server WTRU may be a WTRU offering method determination, assistant data distribution, and/or location calculation functionalities for Sidelink Positioning and Ranging based service.

Network Assisted SL positioning is used to estimate the location of a WTRU with the assistance of the network by using the location of one or more Located WTRUs and the distance and/or direction between the WTRU and the Located WTRU(s). The Network assisted SL Positioning feature has two cases. A first case is when the WTRU can establish a NAS signaling connection. A second case is when the WTRU cannot establish a NAS signaling connection.

When a WTRU can establish a NAS connection, the WTRU enters a connection management (CM)-Connected state by performing a WTRU triggered service request for a 5GC-MO-LR or performing a network triggered service request for a 5GC-network induced (NI)-LR or a 5GC-MT-LR. As the Target WTRU can establish a NAS signaling connection with the AMF, the functionality specified in 5G location service can be reused including, for example, 5GC-MO-LR, 5GC-MT-LR and 5GC-NI-LR. Either the Target WTRU or the LMF determines if network assisted SL positioning will be applied.-The Target WTRU discovers one or more Located WTRUs for network assisted SL positioning. The Target WTRU and the one or more Located WTRUs perform ranging/SL positioning. The Target WTRU includes the WTRU identity of the one or more Located WTRUs to the LMF together with the Ranging measurement data or estimation result. The LMF may interact with GMLC to get the location of Located WTRU. The LMF uses the location of one or more Located WTRUS together with the ranging/SL positioning measurement data or estimation results reported by Target WTRU, and optionally also by Located WTRUs to estimate the location of the Target WTRU.

When the Target WTRU cannot establish the NAS connection with AMF due to the Target WTRU being out of coverage or other reasons (for example, invalid subscription, rejection by the network, and the like), the following principles are applied. The Target WTRU performs the Located WTRU's discovery and selection. The Target WTRU may transmit its ranging measurements/results to the one or more Located WTRUs. Further, the one or more Located WTRUs may report the ranging/SL positioning measurement result to the LMF. This may include ranging measurements/results received from the Target WTRU. The endpoints for LTE positioning protocol (LPP) messages are the LMF and the one or more located WTRUs. The LMF may use the received information to calculate the location of the Target WTRU, and provide the resulting location via the Located WTRU to the Target WTRU, or via the 5G NF to the LCS client or the Application Server.

Examples herein include SL positioning service exposure to a WTRU. A WTRU, which may be referred to as an SL positioning client WTRU, may request SL positioning through PC5 or via the network. When the SL positioning client WTRU requests SL positioning service through the PC5 connection, the WTRU can discover at least one of the Reference WTRU and Target WTRU, and the WTRU may invoke the Ranging/SL Positioning service request to the discovered Reference WTRU/Target WTRU for obtaining the Ranging and SL positioning result between the Reference WTRU and Target WTRU. This request includes the user information of the SL Positioning Client WTRU, Reference WTRU, and Target WTRU. After receiving the SL positioning service request, an SL positioning service operation with an LMF or an SL positioning server WTRU is performed.

Embodiments and examples provided herein explain how a client WTRU can select an appropriate WTRU to perform an SL positioning operation. When an SL positioning client WTRU invokes an SL positioning service request, if the SL positioning client WTRU discovered two or more WTRUs, the SL positioning client WTRU should select one of WTRUs for sending the SL positioning service request.

When a discovered WTRU has a NAS connection and the other discovered WTRU has no NAS connection, the SL positioning service request shall be forwarded to the WTRU that has the NAS connection so that the WTRU may contact an LMF for coordination of service operation. If the service request from the SL positioning client WTRU is sent to the SL reference WTRU that has a NAS connection, it will reduce the extra step otherwise needed to forward the service request to the WTRU that has the NAS connection.

When an SL positioning client WTRU attempts to discover a target WTRU and an SL reference WTRU, and only one or more SL reference WTRUs are discovered, the SL positioning client WTRU shall select an SL reference WTRU to send an SL positioning service request to. In this case, if a WTRU has a NAS connection and the other WTRU has no NAS connection, and in some cases, for example, a service request for absolute positioning of a target WTRU, the SL positioning client WTRU will be better off selecting an SL reference WTRU that has the NAS connection for coordination with the LMF for absolute positioning. Embodiments and examples provided herein explain how a client WTRU can select the proper WTRU to perform an SL positioning operation.

Embodiments and examples provided herein explain how an SL reference WTRU can decide whether it will perform an SL positioning operation or forward an SL positioning service request to the target WTRU. According to a network assisted SL positioning method, a different SL positioning operation is applied according to whether the target WTRU has a NAS connection or no NAS connection. If the target WTRU has no NAS connection, the SL Reference WTRU which has a NAS connection will communicate with an LMF to initiate the SL positioning operation with the LMF.

When a client WTRU sends an SL positioning service request to the SL Reference WTRU, the SL reference WTRU shall be aware of whether the target WTRU has a NAS connection or not, in order to apply the proper SL positioning operation. For example, if the target WTRU has a NAS connection, the SL reference WTRU should forward the SL positioning service request to the target WTRU so that the target WTRU may communicate with LMF to initiate the SL positioning operation. Embodiments and examples provided herein explain how the SL reference WTRU may be aware of whether the target WTRU has a NAS connection or no NAS connection.

Embodiments and examples provided herein explain how an LMF can downselect the proper SL reference WTRU for an SL positioning operation. When a request message for an SL positioning operation is received in the LMF, the LMF may decide on an SL positioning method and may downselect one or more SL reference WTRUs which are proper for the SL positioning operation. If one or more SL reference WTRUs and a target WTRU are in coverage, the NG-RAN and LMF may assign one or more dedicated resources for the SL positioning operation. Embodiments and examples provided herein explain how the LMF can downselect one or more SL reference WTRUs that are in coverage.

In embodiments and examples provided herein, the following terms and phrases may be used interchangeably. For example, SL client WTRU, client WTRU and SL positioning client WTRU may be used interchangeably in embodiments and examples provided herein. Further, SL positioning reference WTRU, SL reference WTRU, and reference WTRU may be used interchangeably in embodiments and examples provided herein. Also, SL positioning server WTRU, SL server WTRU, positioning server WTRU, and server WTRU may be used interchangeably in embodiments and examples provided herein.

An SL positioning client WTRU may send an SL positioning service request to the selected WTRU and based on the selected WTRU's situation stating that the selected WTRU is with a NAS connection or without a NAS connection with involved other WTRUs, an actual SL positioning operation will be performed differently with different entities, such as an LMF or an SL positioning server WTRU. Service initiation to a correct WTRU entity by the SL positioning client WTRU will impact how much signaling should be exchanged until the actual SL positioning operation with right entity occurs, for example the LMF or the SL positioning server WTRU. Embodiments and examples provided herein include two solutions regarding how to efficiently route an SL positioning service request by deciding which entity is to receive the SL positioning service request.

Embodiments and examples provided herein may assume that the WTRU supports PC5 signaling. This PC5 signaling may be supported by the ProSe layer in the WTRUs. Further, in embodiments and examples provided herein, the WTRU may have the capability of ranging and sidelink positioning. In examples, sidelink positioning may refer to the positioning via the PC5 interface, and ranging may refer to the determination of the distance between two or more WTRUs and/or the direction and/or relative positioning of one WTRU to another WTRU.

In embodiments and examples provided herein, after an SL positioning client WTRU discovers a target WTRU and SL reference WTRU, the client WTRU may be informed of the capability and WTRU's NAS status of the target WTRU and SL reference WTRU. Then, based on that information, the client WTRU may select the proper SL reference WTRU for SL positioning operation and may select the proper WTRU to send the SL positioning service request to.

Further, in embodiments and examples provided herein, when an SL reference WTRU receives an SL positioning service request, the SL reference WTRU communicates with the other SL reference WTRU and the target WTRU to get informed of the NAS status of the other SL reference WTRU and the target WTRU. Based on the information above, the SL reference WTRU may determine whether the SL positioning service request needs to be forwarded to the target WTRU or to further proceed with the SL positioning operation.

In addition, embodiments and examples provided herein include a procedure for SL positioning by sharing a WTRU's status. Further, embodiments and examples provided herein include a procedure of SL positioning by a client WTRU based on a WTRU's status. For example, an SL positioning client WTRU may discover a target WTRU and one or more SL reference WTRUs. The SL positioning client WTRU may receive a WTRU's status stating that the WTRU is with a NAS connection or without the NAS connection from discovered WTRUs. If multiple SL reference WTRUs are discovered, based on the WTRU's status and other information, the SL positioning client WTRU may downselect one or more SL reference WTRUs for an SL positioning operation with the target WTRU. The SL positioning client WTRU may send an SL positioning service request to the selected WTRU. The SL positioning service request may include the WTRU's status of the target WTRU and the SL reference WTRU included in the message. Additionally or alternatively, the SL positioning client WTRU may receive the WTRU's status information and other assistance information from the NF in a 5G system (5GS) via NAS signaling, from the AF for Ranging/Positioning or via an SL positioning server WTRU.

Moreover, embodiments and examples provided herein include a procedure of SL positioning based on a WTRU's status between an SL reference WTRU and a target WTRU. For example, an SL positioning client WTRU may receive a WTRU's status stating that the WTRU is with a NAS connection or without the NAS connection from one or more discovered SL reference WTRUs. Based on the WTRU's status and other information, the SL positioning client WTRU may downselect one or more SL reference WTRUs for an SL positioning operation with the target WTRU. Further, the SL positioning client WTRU may an send SL positioning service request to the selected SL reference WTRU.

Additionally, in embodiments and examples provided herein, an SL reference WTRU may receive an SL positioning service request from the client WTRU. Further, the SL reference WTRU may receive the WTRU's status of the target WTRU stating whether the target WTRU is with a NAS connection or without the NAS connection. Based on the WTRU's status of the target WTRU, the SL reference WTRU may decide whether the received SL positioning service request is to be forwarded to the target WTRU or whether the SL reference WTRU is to proceed to SL positioning operation as indicated in the received SL positioning service request.

Embodiments and examples provided herein include a procedure of SL positioning by a client WTRU based on a discover WTRU's status information. In an example, after an SL positioning client WTRU performs discovery and PC5 connection setup with discovered WTRUs, the SL positioning client WTRU may retrieves a WTRU's status, with NAS connection information or with no NAS connection information, and capability information over the PC5 connection. Based on the WTRU's status information and capability, for example, supporting an SL positioning server WTRU, the SL positioning client WTRU can select a proper SL reference WTRU or target WTRU for SL positioning service with the target WTRU according to the WTRU's status. When selecting the proper WTRU, the client WTRU may apply different rules per WTRU's status and requested SL positioning service requirement.

For example, if a target WTRU has no NAS connection and a discovered SL reference WTRU (here WTRU2) is with a NAS connection, a client WTRU may select WTRU2 to send an SL positioning service request to. As a result, the WTRU2 may communicate with an LMF for an SL positioning operation.

For further example, if the target WTRU has no NAS connection but the target WTRU has the capability of an SL positioning server WTRU, the client WTRU may select an SL reference WTRU with no NAS connection when the service request is for relative positioning of the target WTRU.

In another example, if the target WTRU has a NAS connection and an SL reference WTRU has a NAS connection, and another SL reference WTRU without a NAS connection is discovered, the client WTRU may select the SL reference WTRU with a NAS connection for better coordination with the LMF via a direct connection between the LMF and WTRUs. The selection logic of the WTRU for the SL positioning operation, for example, preference of the WTRU with a NAS connection over one without a NAS connection or vice versa, could be influenced by the configuration which is available locally on the client WTRU. This configuration could be provided to the client WTRU via one or more of a graphical user interface (GUI), a User, or 5GS.

The client WTRU may send a service request to the selected WTRU. When sending a service request to the selected WTRU, the client WTRU may include the target WTRU's information and selected SL reference WTRU's information. In addition, the client WTRU may include each WTRU's status, for example, as either having a NAS connection or not.

The selected WTRU may perform an SL positioning operation with the LMF or Server WTRU per a WTRU's status. When receiving an SL positioning service request from a client WTRU, the selected WTRU may select the LMF or SL Positioning server WTRU based on the status of another WTRU and inform the client WTRU regarding the other WTRU's status. In an example, the selected WTRU may inform the client WTRU regarding a target WTRU's status, an SL reference WTRU's status, or both.

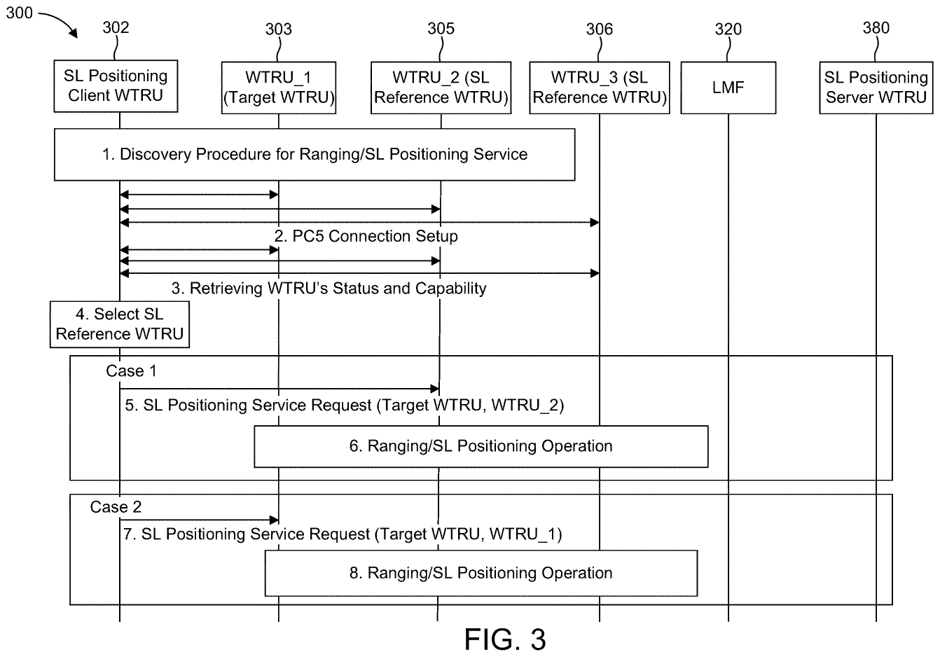

FIG. 3 is a procedure diagram illustrating an example of SL positioning by a client WTRU based on status information of a discovered WTRU. In an example shown in procedure diagram 300, at step 1, the SL positioning client WTRU 302 may be triggered to discover the target WTRU 303 and an SL reference WTRU for an SL positioning service. The discovery procedure may also include ranging, in an example.

In an example, SL positioning client WTRU 302 may discover one or both of SL reference WTRU 305 or SL reference WTRU 306. Further, one or more of SL positioning client WTRU 302, target WTRU 303, SL reference WTRU 305, SL reference WTRU 306, or SL positioning server WTRU 380 may be the same as or similar to WTRU 102. The client WTRU 302 may send a solicitation request message including an indication of an SL positioning service, information regarding a target WTRU 303, and/or information of a requested WTRU's role, for example, here an SL reference WTRU, such as one or both of SL reference WTRU 305 or SL reference WTRU 306.

In step 2, the client WTRU 302 may setup a PC5 connection with discovered WTRUs. The discovered WTRUs may include one or more of target WTRU 303, SL reference WTRU 305, or SL reference WTRU 306.

In step 3, over a PC5 connection, the client WTRU 302 may receive WTRU status information indicating having a NAS connection or no NAS connection from one or more discovered WTRUs. Additionally, the client WTRU 302 may receive capability information of each WTRU. For example, the client WTRU 302 may receive capability information of one or more of target WTRU 303, SL reference WTRU 305, or SL reference WTRU 306.

Additionally, or alternatively, WTRU's status information may be given in another step, for example, a discovery step, a PC5 connection setup step, and the like. Additionally, or alternatively, a WTRU's status information can be delivered by the network function in the 5GS, via NAS signaling. The NFs on the 5GS could be a new function or one or more of existing positioning/ranging related functions, for example LMF 320.

Additionally, or alternatively, WTRU's status information can be delivered by AF for ranging in the 5GS over the User Plane connection. AF for ranging could gather this information from the network data analytics function (NWDAF), which will keep an updated information about the WTRU's status. For example, the updated information may include one or more of in coverage/with NAS connection, out of coverage without NAS connection, capabilities, and the like. Additionally, or alternatively, a WTRU's status information can be delivered by the SL positioning server WTRU 380 over the PC5 connection.

In step 4, based on the information received in step 3, a requested SL positioning service and relating QOS requirement, additionally a WTRU's capability, for example, having SL positioning server capability, the client WTRU 302 may select a WTRU to receive an SL positioning service request from the client WTRU 302. When multiple SL reference WTRUs are discovered, the client WTRU 302 may downselect one or more SL reference WTRUs based on that information. Multiple SL reference WTRUs may be needed based on the positioning service requirements, for example, if higher accuracy or reliability is required.

Additionally, the SL positioning service request from the client WTRU 302 may include a WTRU's status of the included target WTRU 303 (WTRU1) and SL reference WTRU. The one or more SL reference WTRUs may be SL reference WTRU 305, SL reference WTRU 306, or both, in an example shown in FIG. 3.

For example, when the target WTRU information includes indication of having a NAS connection, the WTRU2 information includes indication of having no NAS connection, and WTRU3 information includes indication of having a NAS connection, the client WTRU 302 may select WTRU3 306 for an SL positioning operation with the target WTRU 303 so that the LMF 320 may directly communicate with the WTRU3 306 for coordination of operation.

At step 5 and step 6, as an example of operation, when the target WTRU information includes having no NAS connection and WTRU2 information includes having a NAS connection, the client WTRU 302 may select WTRU2 305 and send an SL positioning service request including the target WTRU information and WTRU2 information to WTRU2 305. The positioning service request may be sent at step 5. When receiving the SL positioning service request, WTRU2 may send an SL positioning service request to the LMF 320 and proceed with the SL positioning operation, such as in step 6. Additionally, the SL positioning service request from the client WTRU 302 at step 5 may include the WTRU's status information of the included target WTRU 303 and SL reference WTRU 305. Further, the SL positioning service request may include ranging, as shown in an example in FIG. 3.

At step 7 and step 8, as an example of operation, when the target WTRU information includes having no NAS connection, the request SL positioning service is relative positioning, and WTRU1 information includes having no NAS connection and having SL positioning server WTRU capability, the client WTRU 302 may select WTRU1 303 for an SL positioning operation and send the SL positioning service request to the WTRU1 303. The positioning service request may be sent at step 7. The WTRU1 303 may proceed with the SL positioning service operation, such as in step 8. Additionally, the SL positioning service request from the client WTRU 302 at step 7 may include the WTRU's status information of the included target WTRU 303 and SL reference WTRU 305. Further, the SL positioning service request may include ranging, as shown in an example in FIG. 3.

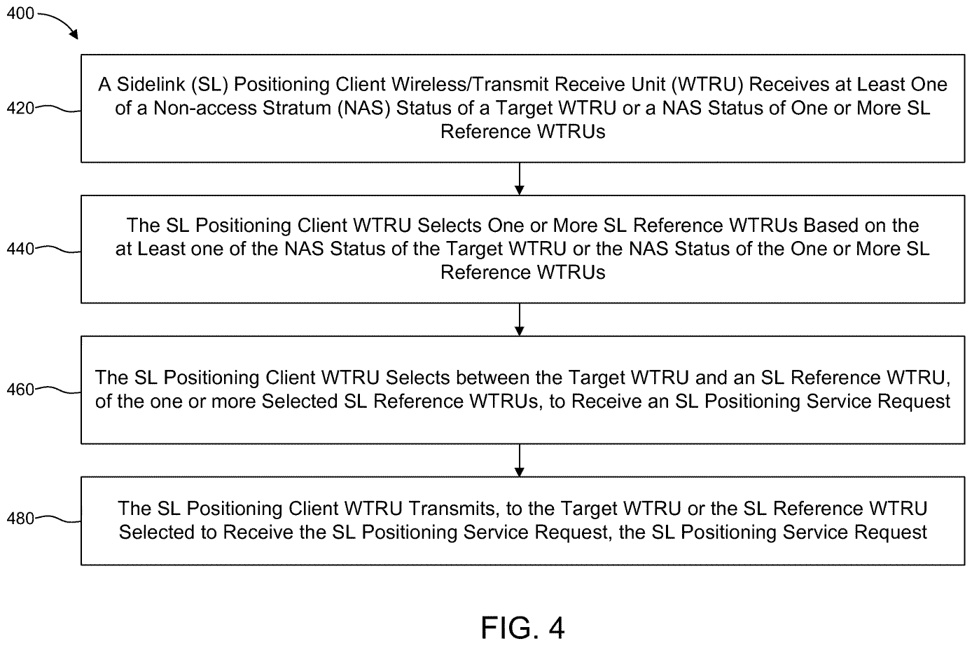

FIG. 4 is a flowchart diagram illustrating an example of SL positioning by a client WTRU based on status information of a discovered WTRU. In an example shown in flowchart diagram 400, an SL position client WTRU may receive at least one of a NAS status of a target WTRU or a NAS status of one or more SL reference WTRUs 420. Further, the SL position client WTRU may select one or more SL reference WTRUs based on the at least one of the NAS status of the target WTRU or the NAS status of the one or more SL reference WTRUs 440. The selection may be performed for an SL positioning operation. Also, the SL position client WTRU may select between the target WTRU and an SL reference WTRU, of the one or more selected SL reference WTRUs, to receive an SL positioning service request 460. Moreover, the SL position client WTRU may transmit, to the target WTRU or the SL reference WTRU selected to receive the SL positioning service request, the SL positioning service request 480.

In a further example, the SL positioning service request may include information regarding the target WTRU, additionally or alternatively. In another example, the SL positioning service request may include information regarding one of the one or more SL reference WTRUs, additionally or alternatively. Additionally or alternatively, the NAS status of the target WTRU and the NAS status of the one or more SL reference WTRUs may be received during discovery.

Additionally or alternatively, the selection between the target WTRU or the selected SL reference WTRU may be based on at least one of the NAS status of the target WTRU or the NAS status of the selected SL reference WTRU, in an example. Additionally or alternatively, the at least one of the NAS status of the target WTRU or the NAS status of the one or more SL reference WTRUs may be received over a PC5 connection.

Embodiments and examples provided herein include a procedure of SL positioning based on WTRU status sharing between the SL reference WTRU and target WTRU. After the SL positioning client WTRU performs Discovery, when SL reference WTRUs are discovered but a target WTRU is not discovered, the client WTRU may setup a PC5 connection with one or more discovered SL reference WTRUs. Over the PC5 connection, the client WTRU may retrieve a status for one or more WTRUs, such as with NAS or without NAS, and capability information over the PC5 connection.

Based on status information for one or more WTRUs and capability, for example, supporting an SL positioning server WTRU, and requested SL positioning service, the client WTRU may select the proper SL reference WTRU for SL positioning service with a target WTRU. For example, if the SL reference WTRU having a NAS connection is discovered, the client WTRU may select the SL reference WTRU for sending an SL positioning service request. For example, if every discovered WTRU reports having no NAS connection but a WTRU has SL positioning server WTRU capability, the client WTRU may select the WTRU having SL positioning server WTRU capability. After selecting the proper WTRU, the client WTRU may send an SL positioning service request to the selected WTRU which may include the target WTRU's information and the SL Reference WTRU's information.

When an SL reference WTRU receives an SL positioning service request from a client WTRU, the SL reference WTRU may set up a PC5 connection with the target WTRU and retrieve the target WTRU's status. For example, the SL reference WTRU may retrieve a status regarding whether the target WTRU has a NAS connection or no NAS connection. Based on the target WTRU's status, the SL reference WTRU may decide whether it proceeds with SL positioning operation by selecting the LMF or the SL positioning server WTRU according to the status of SL reference WTRU and target the WTRU. The status may include, for example, having NAS connection or not. Then, the SL reference WTRU may forward the service request to the target WTRU. When the SL reference WTRU is informed that the target WTRU has a NAS connection, the SL reference WTRU may forward the received SL positioning service request to the target WTRU, and the target WTRU may proceed further for SL positioning service operation by contacting the LMF.

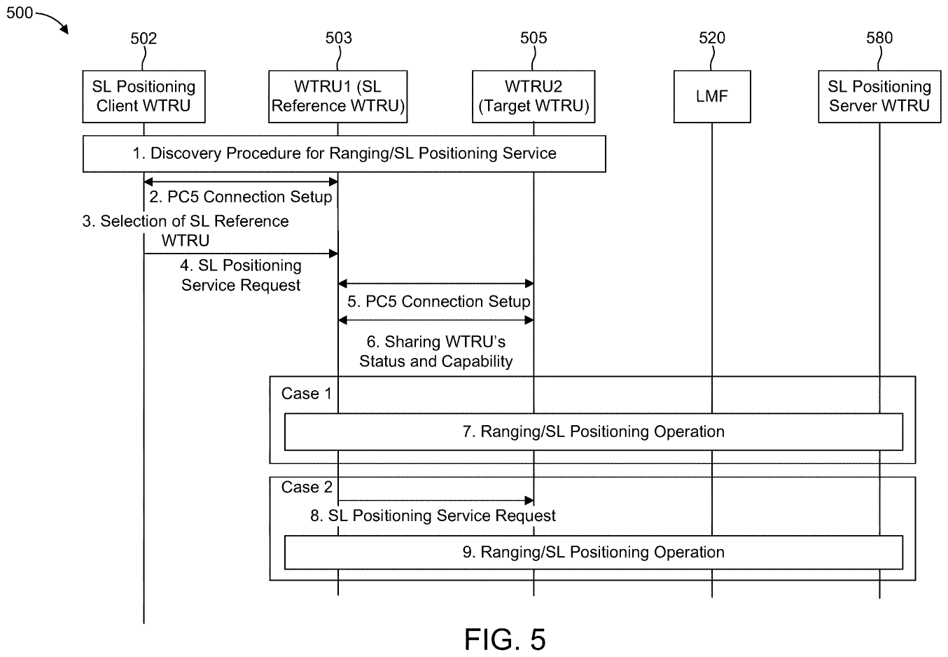

FIG. 5 is a procedure diagram illustrating an example of SL positioning WTRU status sharing between an SL reference WTRU and a target WTRU. At step 1, the SL positioning client WTRU 502 may be triggered to discover the target WTRU 505 and SL reference WTRU 503 for SL positioning service, in an example shown in procedure diagram 500. The discovery procedure may also include ranging, in an example. Further, one or more of SL positioning client WTRU 502, SL reference WTRU 503, or SL positioning server WTRU 580 may be the same as or similar to WTRU 102

The client WTRU 502 may send a solicitation request message including an indication of SL positioning service, information about the target WTRU 505, and information about the requested WTRU's role, for example, here the SL reference WTRU 503. In an example shown in FIG. 5, the SL positioning client WTRU 502 may discover only the SL reference WTRU(s) including WTRU1 503 but does not hear a response from WTRU2 505, a target WTRU, in an example.

At step 2, the SL positioning client WTRU 502 may setup a PC5 connection with discovered WTRU(s). At step 3, over the PC5 connection, the SL positioning client WTRU 502 may receive WTRU status indicating having a NAS connection or no NAS connection from discovered WTRU(s). Additionally, the SL positioning client WTRU 502 may receive capability information of each WTRU. Additionally, or alternatively, status information for one or more WTRUs may be given in another step, for example, in a discovery step, PC5 connection setup step, and the like.

Additionally, or alternatively, WTRU's status information can be delivered by the network function in the 5GS, via the NAS signaling. The NF's on the 5GS could be a new function or existing positioning/ranging related functions, for example, the LMF 520. Additionally, or alternatively, WTRU's status information can be delivered by AF for ranging in the 5GS over the User Plane connection. AF for ranging could gather this information from the NWDAF, which will keep an updated information about the WTRU's status, for example, in coverage/with a NAS connection, out of coverage without a NAS connection, capabilities, and the like. Additionally, or alternatively, WTRU's status information can be delivered by the SL positioning server WTRU 580 over the PC5 connection.

At step 4, based on the information received in step 3, the requested SL positioning service and relating QoS requirement, and additionally capabilities of one or more WTRUs, for example, having SL positioning server capability, the client WTRU may downselect one or more SL reference WTRUs, such as SL reference WTRU 503. Also, the SL positioning client WTRU 502 may send an SL positioning service request to the selected SL reference WTRU 503, also shown as WTRU1 in an example in FIG. 5. Multiple SL reference WTRUs may be needed based on the positioning service requirements, for example, if a higher accuracy or reliability is required.

At step 5, after receiving the SL positioning service request, WTRU1 503 may setup a PC5 connection with the target WTRU 505 (WTRU2). At step 6, over the PC5 connection, the SL reference WTRU 503 (here WTRU1) and the target WTRU 505 (here WTRU2) exchange status information of the WTRUs, for example, information regarding with NAS connection or no NAS connection. Additional capabilities may also be exchanged.

At step 7, as an example, if the target WTRU 505 (here WTRU2) is without NAS connection and this information is provided to WTRU1 503, then WTRU1 503 may select the SL positioning server WTRU 580 or the LMF 520 based on the status of the SL positioning server WTRU 580, the LMF 520 or both. WTRU1 503 may also proceed with an SL positioning operation.

At step 8, as an example, if the target WTRU 505 (WTRU2) information includes having a NAS connection, WTRU1 503 may forward an SL positioning service request to WTRU2 505. Further, at step 9, WTRU2 505 may proceed with an SL positioning operation with the LMF 580.

Examples of selection of an SL positioning server WTRU by the LMF are provided herein. When the LMF 520 is selected and reached by the target WTRU 505 or SL reference WTRU 503 for an SL positioning operation, for example, in step 7 or 9 of solution in FIG. 5, the LMF 520 may involve an SL positioning server WTRU 580 in lieu of the LMF 520.

The LMF 520 may determine, based on criteria whether and which SL positioning server WTRU should be involved and for which functionality the SL positioning server WTRU should be involved, for example, positioning result calculation, distributing of assistance data, and the like. In an example, the criteria may include one or more of to off-load, insufficient resources, an availability of a free positioning server WTRU in the area, and the like.

When the LMF 520 decides a SL positioning server WTRU should be involved, the LMF 520 may send this information to the target WTRU 505 or SL reference WTRU 503. And the LMF 520 may send an indication to the SL positioning server that it should perform SL positioning service assistance for the target WTRU 505 and SL reference WTRU 503, and may send information about the received SL positioning service request. The LMF 520 may provide a list of available SL positioning server WTRU(s) in the service area so that the server WTRU may discover one or more other server WTRUs if needed for supporting some functionality for coordination of an SL positioning operation.

Embodiments and examples provided herein include sharing WTRU status information to the SL positioning service request toward an LMF. When the target WTRU or SL reference WTRU sends a request for an SL positioning operation, one or more SL reference WTRUs' information and target WTRU's information may be included in the request message. This request message may be seen, for example in step 5 in the example solutions found in FIG. 3 and related text, and in step 8 the example solutions found in FIG. 5 and related text. Further, each WTRU's status, for example, with a NAS connect or without a NAS connect, may be included in the request message.

When multiple SL Reference WTRUs are included in the SL positioning service request, for coordination of SL positioning operation, the LMF may downselect SL Reference WTRUs which are proper to perform an SL positioning operation with consideration of the status of one or more WTRUs, for example, having a NAS connection or having no NAS connection. Based on the WTRU status information of the target WTRU and selected one or more SL reference WTRUs having a NAS connection, the LMF and NG-RAN may coordinate to perform an SL positioning operation in a dedicated resource for the requested SL positioning operation.

Although features and elements are described above in particular combinations, one of ordinary skill in the art will appreciate that each feature or element can be used alone or in any combination with the other features and elements. Also, the methods described herein may be implemented by means configured to perform the features and elements described above. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a sidelink (SL) positioning client wireless/transmit receive unit (WTRU), the method comprising:
discovering a target WTRU and one or more SL reference WTRUs in a discovery procedure;
receiving, during the discovery procedure, at least one of a non-access stratum (NAS) status of the target WTRU or a NAS status for each of the one or more SL reference WTRUS;
selecting one or more of the one or more SL reference WTRUs, for an SL positioning operation, based on the at least one of the NAS status of the target WTRU or the NAS status for each of the one or more SL reference WTRUs;
selecting, based on at least one of the NAS status of the target WTRU or the NAS status of the selected one or more SL reference WTRUs, a WTRU between the target WTRU and an SL reference WTRU, of the one or more selected SL reference WTRUs, to receive an SL positioning service request; and
transmitting, to the selected target WTRU or the selected SL reference WTRU selected to receive the SL positioning service request, the SL positioning service request.

2. The method of claim 1, wherein the SL positioning service request includes information regarding the target WTRU.

3. The method of claim 1, wherein the SL positioning service request includes information regarding one of the one or more SL reference WTRUs.

4. (canceled)

5. (canceled)

6. The method of claim 1, wherein at least one of the NAS status of the target WTRU and the NAS status of the one or more SL reference WTRUs are received over a PC5 connection.

7. A sidelink (SL) positioning client wireless/transmit receive unit (WTRU) comprising:
a transceiver; and
a processor operatively coupled to the transceiver; wherein:
the transceiver and the processor are configured to discover a target WTRU and one or more SL reference WTRUs in a discovery procedure;
the transceiver is configured to receive, during the discovery procedure, at least one of a non-access stratum (NAS) status of the target WTRU or a NAS status for each of the one or more SL reference WTRUs;
the processor is configured to select one or more of the one or more SL reference WTRUs, for an SL positioning operation, based on the at least one of the NAS status of the target WTRU or the NAS status for each of the one or more SL reference WTRUS;
the processor is configured to select, based on at least one of the NAS status of the target WTRU or the NAS status of the selected one or more SL reference WTRUS, a WTRU between the target WTRU and an SL reference WTRU, of the one or more selected SL reference WTRUs, to receive an SL positioning service request; and
the transceiver and the processor are configured to transmit, to the selected target WTRU or the selected SL reference WTRU selected to receive the SL positioning service request, the SL positioning service request.

8. The SL WTRU of claim 7, wherein the SL positioning service request includes information regarding the target WTRU.

9. The SL WTRU of claim 7, wherein the SL positioning service request includes information regarding one of the one or more SL reference WTRUs.

10. (canceled)

11. (canceled)

12. The SL WTRU of claim 7, wherein at least one of the NAS status of the target WTRU and the NAS status of the one or more SL reference WTRUs are received over a PC5 connection.

13. A target wireless/transmit receive unit (WTRU) comprising:
a transceiver; and
a processor operatively coupled to the transceiver; wherein:
the transceiver and the processor are configured to transmit a non-access stratum (NAS) status of the target WTRU, during a discovery procedure; and
the transceiver is configured to receive a sidelink (SL) positioning service request.

14. The target WTRU of claim 13, wherein the SL positioning service request includes information regarding the target WTRU.

15. (canceled)
